(19) United States
(12) Patent Application Publication
(10) Pub. No.: US 2008/0216324 A1
(43) Pub. Date: Sep. 11, 2008

(54) Surgical hair trimmer

(76) Inventor: Mark Tauer, Belchertown, MA (US)

Correspondence Address: Kendall (CDFS), 445 BROAD HOLLOW ROAD, SUITE 225, MELVILLE, NY, 11747, US

(21) Appl. No.: 11/716,501

(22) Filed: Mar. 8, 2007

(51) Int. Cl. B26B 19/28

(52) U.S. Cl. 30/42

(57) ABSTRACT

A surgical hair trimmer is provided including a handle assembly including a power source, a drive motor connected to the power source and having a drive shaft extending therefrom, and a release mechanism configured and adapted for single handed operation; and a blade assembly including a pair of blades wherein at least one of the pair of blades is movable with respect to the other of the pair of blades, an interconnect configured and adapted to operatively couple the drive shaft to the movable blade when the blade assembly is connected to the handle assembly, and engagement structure configured and adapted to selectively engage the release mechanism of the handle assembly. In use, actuation of the release mechanism, when the blade assembly is connected to the handle assembly, jettisons the blade assembly from the handle assembly.

### BACKGROUND

1. Technical Field

The present disclosure relates generally to medical devices and, more particularly, to a surgical hair trimmers.

2. Discussion of Related Art

Technological advances in medicine have allowed for hair removal to be achieved by a variety of means, including and not limited to razors, depilatory agents, and electric hair trimmers.

A drawback to razor preparation of irregular or bony areas is that such preparation often results in either inadequate hair removal and/or injury, such as, irritation, inflammation, nicks and scratches. Such injury to the skin, as a result of razor preparation, may result in an increase in the rate of infection.

A drawback to the use of depilatory agents is that use of depilatory agents may result in irritation and/or an allergic reaction (i.e., rash) in the patient. However, the use of depilatory agents often results in fewer disruptions of skin integrity as compared to razor preparation.

It has been found that either hair trimmers or depilatory agents have less potential of disrupting skin integrity. Since hair trimmers result in less irritation to the skin as compared to the use of depilatory agents and since hair trimmers result in fewer skin disruptions as compared to razors, the use of clippers to prepare the skin of a patient prior to a surgical procedure has emerged as the preferred method of skin preparation.

Therefore, a need exists for improved and more efficient surgical hair trimmers and the like.

The improved surgical hair trimmers should reduce the preparation time required for a patient thus reducing the time the patient spends in the operating room and thus the total cost for the use of the operating room.

The improved surgical hair trimmers should reduce incidents of clogging.

The improved surgical hair trimmers should reduce the amount of clinician contact with sharps and the like, such as, the blade thereof.

The improved surgical hair trimmers should reduce the amount of clinician contact with the hair of the patient either prior to or after the clipping procedure.

### SUMMARY

The present disclosure relates surgical hair trimmers. According to an aspect of the present disclosure, a surgical hair trimmer is provided and comprises a surgical hair trimmer, comprising a handle assembly including a handle housing configured and dimensioned to house a power supply and a drive motor, wherein the drive motor includes a drive shaft extending through a distal end of the handle housing; and a release mechanism associated with the handle housing. The release mechanism includes a pair of clasps each pivotally supported in a release housing at a respective pivot point, each clasp including a leg portion extending in a first direction from the pivot point and an arm portion extending in a second direction from the pivot point, the arm portion of each clasp defining a distal finger configured and adapted for engaging a blade assembly; and a release button operatively associated with the leg portion of each clasp.

The surgical hair trimmer further includes a blade assembly selectively connectable to the handle assembly. The blade assembly includes a blade housing configured and dimensioned to house a pair of trimmer blades; and an engagement structure formed in blade housing for selectively engaging the distal finger of each arm portion of each clasp.

The surgical hair trimmer also includes a biasing member operatively associated with each clasp for maintaining said arms in a first position relative to one another.

In use, when the blade assembly is connected to the handle assembly the distal end of the arm of each clasp of the release mechanism engages with a corresponding engagement structure of the blade housing of the blade assembly, and wherein actuation of the release button of the release mechanism jettisons the blade assembly from the handle assembly.

The release button may be provided on an upper surface of the handle housing. The distal end of the arm of at least one clasp may extend in an inward direction. The surgical hair trimmer may further include at least one visual indicator supported on the handle housing. The surgical hair trimmer may include a distal end of the handle housing includes a shroud extending therefrom.

In an embodiment, the leg portion and the arm portion of each clasp may be oriented at an angle with respect to one another. The biasing member may tend to maintain the distal end of each arm portion of each clasp relatively approximated toward one another. The biasing member may be operatively associated with at least one of the release mechanism and the blade assembly.

The biasing member may include at least one leaf spring extending from the blade housing and in operative contact with a respective leg portion of each clasp when the blade assembly is connected to the handle assembly. The biasing member may include at least one leaf spring extending from each clasp and in operative contact with the housing of the release mechanism. The biasing member may tend to maintain the release button in an extended condition when the blade assembly is connected to the handle assembly.

According to another aspect of the present disclosure, a surgical hair trimmer is provided that comprises a handle assembly including a power source, a drive motor connected to the power source and having a drive shaft extending therefrom, and a release mechanism configured and adapted for single handed operation; and a blade assembly including a pair of blades wherein at least one of the pair of blades is movable with respect to the other of the pair of blades, and engagement structure configured and adapted to selectively engage the release mechanism of the handle assembly. In use, actuation of the release mechanism, when the blade assembly is connected to the handle assembly, jettisons the blade assembly from the handle assembly.

The release mechanism may include a pair of clasps each pivotally supported in a release housing at a respective pivot point. Each clasp may include a leg portion extending in a first direction from the pivot point and an arm portion extending in a second direction from the pivot point, the arm portion of each clasp defining a distal finger configured and adapted for engaging a blade assembly. The release mechanism may further include a release button operatively associated with the leg portion of each clasp.

The blade assembly may include a blade housing configured and dimensioned to house a pair of trimmer blades; and an engagement structure formed in blade housing for selectively engaging the distal finger of each arm portion of each clasp.

The surgical hair trimmer may further include a biasing member operatively associated with each clasp for maintaining said arms in a first position relative to one another. In use, when the blade assembly is connected to the handle assembly the distal end of the arm of each clasp of the release mechanism engages with a corresponding engagement structure of the blade housing of the blade assembly, and wherein actuation of the release button of the release mechanism jettisons the blade assembly from the handle assembly.

The release button may be provided on an upper surface of the handle housing. The distal end of the arm of at least one clasp may extend in an inward direction. The surgical hair trimmer may further include at least one visual indicator supported on the handle housing. A distal end of the handle assembly may include a shroud extending therefrom.

The leg portion and the arm portion of each clasp may be oriented at an angle with respect to one another.

The biasing member may tend to maintain the distal end of each arm portion of each clasp relatively approximated toward one another. The biasing member may be operatively associated with at least one of the release mechanism and the blade assembly. The biasing member may include at least one leaf spring extending from the blade housing and in operative contact with a respective leg portion of each clasp when the blade assembly is connected to the handle assembly. The biasing member may include at least one leaf spring extending from each clasp and in operative contact with the housing of the release mechanism. The biasing member may tend to maintain the release button in an extended condition when the blade assembly is connected to the handle assembly.

### DETAILED DESCRIPTION OF THE DRAWINGS

Various embodiments of the presently disclosed surgical hair trimmers are disclosed herein with reference to the drawings, wherein:

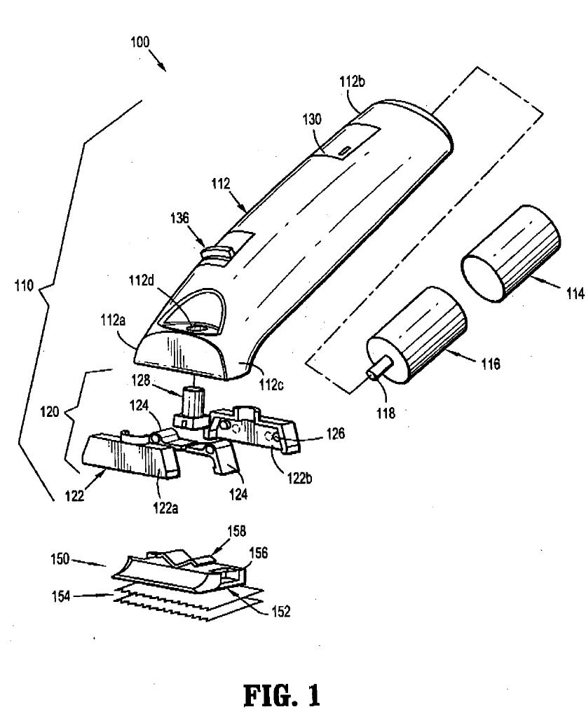

FIG. 1 is a schematic, exploded, perspective view of a surgical hair trimmer according to an embodiment of the present disclosure;

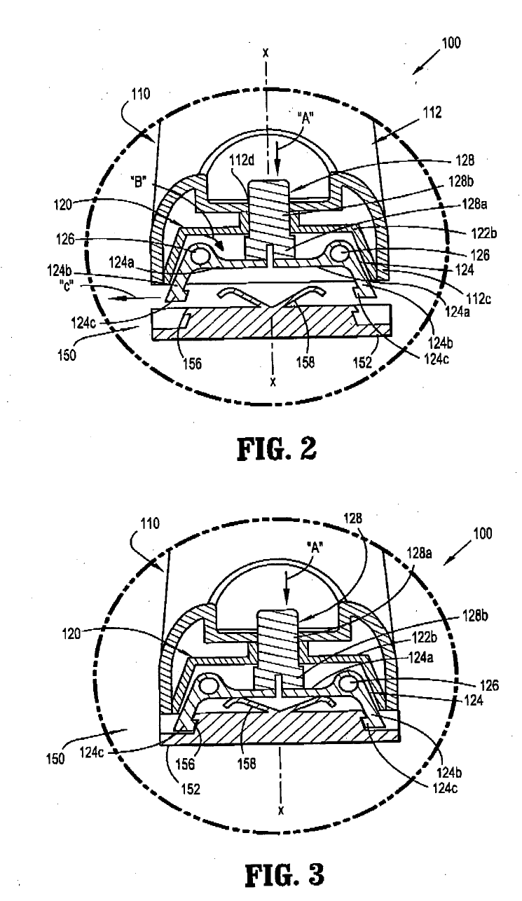

FIG. 2 is a cross-sectional view of the surgical hair trimmer of FIG. 1, as taken through 2-2 of FIG. 1 and illustrating an assembled blade assembly separated from an assembled handle assembly;

FIG. 3 is a cross-sectional view of the surgical hair trimmer of FIG. 2, illustrating the assembled blade assembly fully connected to the handle assembly;

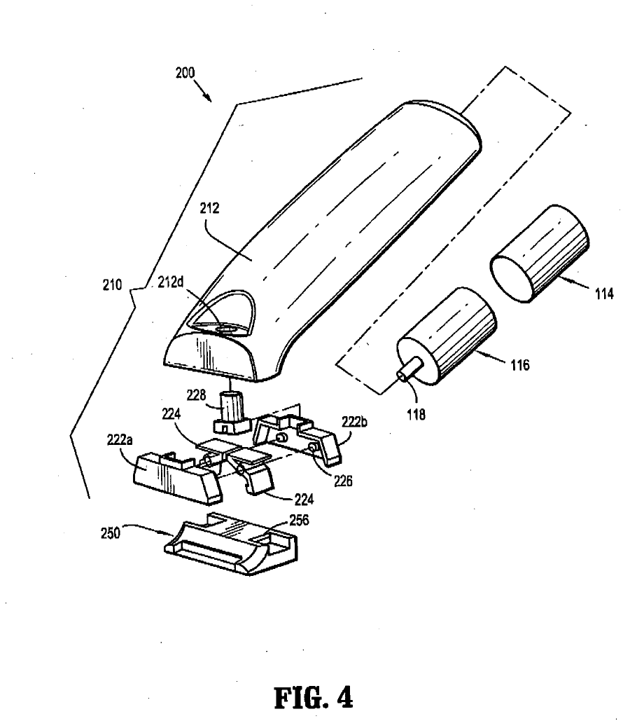

FIG. 4 is a schematic, exploded, perspective view of a surgical hair trimmer according to another embodiment of the present disclosure;

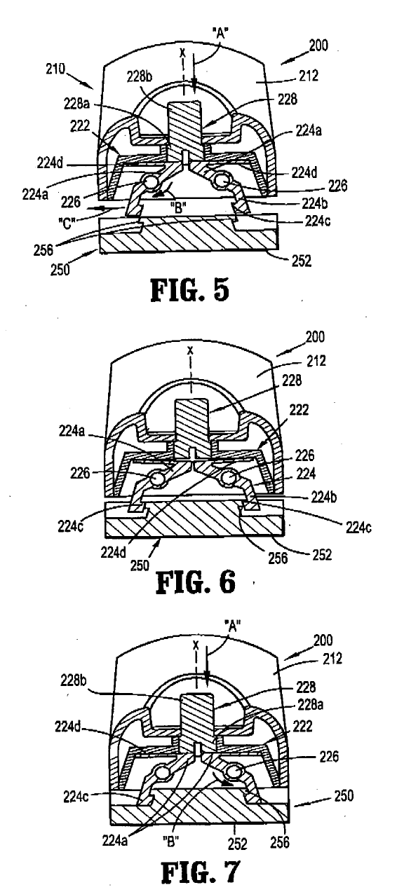

FIG. 5 is a cross-sectional view of the surgical hair trimmer of FIG. 4, as taken through 5-5 of FIG. 4 and illustrating an assembled blade assembly separated from an assembled handle assembly;

FIG. 6 is a cross-sectional view of the surgical hair trimmer of FIG. 4, illustrating the assembled blade assembly partially connected to the handle assembly; and

FIG. 7 is a cross-sectional view of the surgical hair trimmer of FIG. 4, illustrating the assembled blade assembly fully connected to the handle assembly.

### DETAILED DESCRIPTION OF EMBODIMENTS

The surgical hair trimmers of the present disclosure provide the operator, e.g., health care professional, with an increased ability to remove hair from a target surgical site prior to performing a surgical procedure. Moreover, the surgical hair trimmers of the present disclosure provide for a safe, reliable and efficient method of removing hair from the target surgical site while minimizing the incidents of skin irritation and/or injury.

In the following description, as is traditional, the term “proximal” refers to the portion of the apparatus or device which is closest to the operator while the term “distal” refers to the portion of the apparatus or device which is remote from the operator.

According to an embodiment of the present disclosure, as seen in FIGS. 1-3, a surgical hair trimmer is generally designated as 100. Surgical hair trimmer 100 includes a handle assembly 110 and a selectively removable blade assembly 150 operatively connectable to handle assembly 110.

As seen in FIG. 2, handle assembly 110 includes a handle housing 112 having an ergonomic outer profile which may be substantially similar to the outer profile of the any of the outer or fluid housings disclosed in U.S. application Ser. No. 11/200,460, filed on Aug. 8, 2005, the entire content of which is incorporated herein by reference. Handle housing 112 may be made of durable, impact-resistant molded polymeric or plastic material, as is known in the art.

Handle assembly 110 may include a rigid inner casing and a soft material over-mold giving handle assembly 110 a soft feel. It is contemplated that the over-mold may incorporate bumps, ridges, slots, grooves, dimples, knurling, etc, formed therein or thereon which improves the gripping ability of handle assembly 110. It is contemplated that the handle assembly 110 may have a substantially ovular transverse cross-sectional profile.

Handle housing 112 includes a drive or distal end 112a, and a recharge or proximal end 112b located substantially opposite drive end 112a. Handle housing 112 defines a longitudinal “X” axis (see FIGS. 2 and 3). Handle assembly 110 includes a power source 114 (shown in phantom in FIG. 1) housed or retained within handle housing 112. Power source 114 may include, and is not limited to, one or more rechargeable batteries, disposable batteries, or an electric transformer connectable to a power cord which is connectable to an electrical outlet. In the present embodiment, electrical terminals (not shown) for engaging a power cord or a charging base are located at recharge end 112b of handle housing 112.

With continued reference to FIG. 1, handle assembly 110 further includes a drive member 116 (shown in phantom), in the form of an electric motor or the like, housed or retained within handle housing 112 and operatively connected to power source 114 in a manner known in the art. Drive member 116 includes a drive shaft 118 extending therefrom and toward drive end 110a of handle assembly 110. Drive shaft 118 may include an eccentric cam (not shown), supported thereon, as known by one having skill in the art. The arrangement and operation of power source 114, drive member 116 and the eccentric cam of drive shaft 118 are similar to components which are well known in the art.

As seen in FIGS. 1-3, handle assembly 110 further includes a blade assembly attachment and release mechanism 120 supported on or in handle housing 112. Release mechanism 120 includes a housing 122 having a first half-section 122a and a second half-section 122b securable to one another. Housing 122 of release mechanism 120 is configured and adapted for attachment or selective attachment to handle housing 112.

Release mechanism 120 further includes a pair of clasps 124 pivotally supported in housing 122 of release mechanism 120 via a respective pivot pin 126 or other suitable structure, such as, for example, a pivot boss formed in and extending from at least one half-section 122a, 122b of housing 122 of release mechanism 120. Each clasp 124 has a substantially L-shaped profile including a leg portion 124a extending in a first direction relative to a pivot point thereof, and an arm portion 124b extending in a second direction relative to the pivot point thereof, wherein the arm portion 124b is oriented at an angle with respect to the leg portion 124a.

As seen in FIGS. 2 and 3, each clasp 124 is supported in opposed sides of housing 122 of release mechanism 120 in such a manner that leg portions 124a of each clasp 124 are oriented substantially toward one another and toward the longitudinal “X” axis. Also, as seen in FIGS. 2 and 3, arm potions 124b of each clasp 124 are oriented in a substantially distal direction. A distal end 124c of each arm portion 124b defines a finger configured and adapted to selectively engage a coupler formation provided on blade assembly 150, as will be described in greater detail below. As seen in FIGS. 2 and 3, arm portions 124b of each clasp 124 are disposed outward of respective pivot points 126.

With continued reference to FIGS. 1-3, release mechanism 120 further includes a release button 128 operatively supported within housing 122 of release mechanism 120. Release button 128 includes a base portion 128a retained within housing 122 or release mechanism 120 and operatively engaged with, connected to or supported on both leg portions 124a of clasps 124. Release button 128 further includes a head portion 128b extending from housing 122 of release mechanism 120 and being configured and adapted to manipulation by a finger of a clinician.

In an alternate embodiment, release button 128 may be located at a proximal end of handle assembly 110 (not shown). Reference may be made to commonly-owned, U.S. application Ser. No. ______ , filed on Mar. 8, 2007, under a Certificate of Express Mail No. EV958088535US, entitled “Surgical Hair Trimmer”, the entire content of which is incorporated herein by reference, for a detailed discussion of the construction and operation of a release button disposed at a proximal end of a handle assembly of a surgical hair trimmer.

In use, as will be described in greater detail below, when release button 128 is pressed (as indicated by arrow “A” of FIG. 2), release button 128 acts on leg portions 124a of clasps 124, moving the ends of leg portions 124a in a substantially distal direction and causing clasps 124 to rotate about pivot points 126 (as indicated by arrow “B” of FIG. 2) to move arm portions 124b and distal fingers 124c in a substantially outward direction (as indicated by arrow “C” of FIG. 2).

Release mechanism 120 is configured and adapted to enable the clinician to attach and remove blade assembly 150 to/from handle assembly 110 with a single hand. In particular, as will be discussed in detail below, the clinician may hold handle assembly 110 in a single hand, actuate release mechanism 120 with the same hand, and attach/detach bade assembly 150 to/from handle assembly 110 with the same hand. In this manner, contact of the clinicians other hand, with the blade assembly 150 or the like is eliminated, thereby reducing instances of contact or injury with the sharp of the blade assembly 150.

With continued reference to FIGS. 1-3, handle housing 112 includes a shroud 112c extending in a distal direction therefrom. In use, shroud 112c extends an amount or distance sufficient to contact or engage a surface of a housing of blade assembly 150. In this manner, debris, such as, hair clippings or the like, is substantially prevented from contaminating release mechanism 120 and/or drive shaft 118.

As seen in FIGS. 1-3, handle housing 112 includes an aperture 112d configured and dimensioned to receive or have head portion 128b of release button 128 extend therethrough.

As seen in FIG. 1, handle assembly 110 may include a visual indicator 130 supported on handle housing 112. Visual indicator 130 may be any suitable display known in the art to provide an indication of an event. The event may be related to the procedure or the operation of the surgical hair trimmer 100, such as, for example, battery life, blade assembly life, etc. Visual indicator 130 may be a liquid crystal display (LCD), a plasma display, one or more light emitting diodes (LEDs), a luminescent display, a multi-color display, a digital display, an analog display, a passive display, an active display, a so called “twisted nematic” display, a so called “super twisted nematic” display, a “dual scan” display, a reflective display, a backlit display, an alpha numeric display, a monochrome display, a so called “Low Temperature Polysilicon Thin Film Transistor” (LPTS TFT) display, or any other suitable display that indicates a parameter, information or graphics related to the procedure or surgical hair trimmer 100.

In one embodiment, visual indicator 130 is a liquid crystal display which may be a black & white or color display that displays one or more operating parameters of surgical hair trimmer 100 to the clinician. In one embodiment, the operating parameter displayed may be the life of the battery, the life of the blade assembly, or any other parameter of the procedure. The visual indicator 130 may display text, graphics or a combination thereof.

In addition to visual indicator 130, handle assembly 110 may incorporate a tactile feedback mechanism (not shown) associated therewith. In this manner, during operation of surgical hair trimmer 100, in addition to or in lieu of visual indicator 130, the clinician is advised of the conditions or parameters of surgical hair trimmer 100 as a result of a vibratory response generated by the tactile feedback mechanism. It is contemplated that any suitable tactile feedback mechanism, known in the art, may be incorporated into handle assembly 110.

The tactile feedback mechanism may be configured to activate when the power level of the surgical hair trimmer (e.g., the battery charge) drops below a predetermined threshold level. It is envisioned that the tactile feedback mechanism may cause the surgical hair trimmer to vibrate at different intensities depending on the particular power level remaining.

As seen in FIG. 1, handle assembly 110 includes an activation button or slide 136 supported on handle housing 112. Activation button or slide 136 functions to activate and de-activate drive member 116, as desired or needed, by the clinician. Activation button or slide 136 may be supported on handle housing 112 and connected to each of power source 114 and drive member 116 according to any suitable method known in the art.

With continued reference to FIGS. 1-3, a detailed discussion of blade assembly 150 is provided. Blade assembly 150 includes a blade housing 152 configured and adapted to operatively support a pair of hair trimmer blades 154 therein. As is conventional, one of the pair of hair trimmer blades is stationary, while the other of the hair trimmer blades 154 is slidably moveable with respect to the stationary blade.

As seen in FIGS. 1-3, blade assembly 150 includes an engagement structure or couple formation 156 formed in a surface of blade housing 152. Engagement structure 156 is configured and adapted to selectively engage with distal fingers 124c of each clasp 124 of release mechanism 120. Engagement structure 156 is configured and adapted such that a secure engagement between handle assembly 110 and blade assembly 150 is achieved when blade assembly 150 is coupled to handle assembly 110. Additionally, engagement structure 156 is configured and adapted such that upon actuation of the release button 128, blade assembly 150 is automatically separated from handle assembly 110.

In particular, blade assembly 150 includes a biasing member 158, in the form of a leaf-spring or the like, supported on blade housing 152. Biasing member 158 is supported on blade housing 152 at a location such that when blade assembly 10 is connected to handle assembly 110, biasing member 158 is operatively associated with at least one leg portion 124a of clasp 124. Additionally, when blade assembly 10 is connected to handle assembly 110, biasing member 158 is flexed or biased against leg portions 124a of clasp 124. In this manner, as will be described in greater detail below, when release button 128 of release mechanism 120 is actuated to separate blade assembly 150 from handle assembly 110, biasing member 158 un-flexes or un-biases thereby jettisoning blade assembly 150 from handle assembly 110.

With reference to FIGS. 2 and 3, a method of using surgical hair trimmer 100 with handle assembly 110 and blade assembly 150 is shown and described. As seen in FIG. 3, when blade assembly 150 is attached or connected to handle assembly 110, distal fingers 124c of clasps 124 snap-over and engage respective coupling formations 156 of blade assembly 150. In so doing, biasing members 158 are flexed or biased, as described above, and the forces on leg portions 124a of clasps 124 urge release button 128 to extend out of aperture 112d of handle housing 112.

Following use of surgical hair trimmer 100, blade assembly 150 is detached from handle assembly 110 and either discarded or sanitized for re-use. In order to detach blade assembly 150 from handle assembly 110, the clinician presses down on release button 128, as indicated by arrow “A” of FIG. 2, thereby pressing base portion 128a of release button 128 into and against leg portions 124a of clasps 124. As the ends of leg portions 124a of clasps 124 are urged in a downward direction, i.e., in the direction of arrow “A”, clasps 124 are rotated about pivot points 126, as indicated by arrow “B” of FIG. 2. As clasps 124 are rotated about pivot points 126, distal fingers 124c of clasps 124 disengage from respective coupling formations 156 of blade assembly 150 and the ends of leg portions 124a further flex or bias biasing member 158.

Once distal fingers 124c of clasps 124 are free from or fully disengaged from respective coupling formation 156 of blade assembly 150, blade assembly 150 is forced, pushed or jettisoned off of or detached from handle assembly 110 by the un- or flexing or un-biasing force stored in biasing member 158.

Turning now to FIGS. 4-7, a surgical hair trimmer according to an alternate embodiment of the present disclosure is generally designated as 200. Surgical hair trimmer 200 is substantially identical to surgical hair trimmer 100 and thus will only be discussed further herein to the extent necessary to identify differences in construction and operation.

As seen in FIGS. 4-7, a release mechanism 220 of handle assembly 210 includes a housing 222 having a first half-section 222a and a second half-section 222b securable to one another. Housing 222 of release mechanism 220 is configured and adapted for attachment or selective attachment to handle housing 212 of handle assembly 210.

Release mechanism 220 further includes a pair of clasps 224 pivotally supported in housing 222 of release mechanism 220 via a respective pivot boss 226 extending from at least one half-section 222a, 222b of housing 222 of release mechanism 220. Each clasp 224 includes a leg portion 224a extending in a first direction relative to a pivot point thereof, and an arm portion 224b extending in a second direction relative to the pivot point thereof, wherein the arm portion 224b is oriented at an angle with respect to the leg portion 224a.

As seen in FIGS. 5-7, each clasp 224 is supported in opposed sides of housing 222 of release mechanism 220 in such a manner that the ends of each leg portion 224a of each clasp 224 are oriented substantially toward one another and toward the longitudinal “X” axis. Also, as seen in FIGS. 5-7, arm potions 224b of each clasp 224 are oriented in a substantially distal direction. A distal end 224c of each arm portion 224b defines a finger configured and adapted to selectively engage a coupler formation provided on blade assembly 250, as will be described in greater detail below. As seen in FIGS. 5-7, arm portions 224b of each clasp 224 are disposed outward of respective pivot points 26.

Each clasp 224 includes a biasing member 224d extending from leg portion 224a. The biasing members 224d are in contact with a surface of housing 222 of release mechanism 220 and tend to maintain distal fingers 224c of clasps 224 in relative close proximity to one another. In particular, each biasing member 224d extends from an end of each respective leg portion 224a of clasp 224 to a location outward of pivot point 226, and includes a free end which is in contact with an upper surface of housing 222 of release mechanism 220. Biasing members 224d may be leaf springs or any other suitable resilient member or structure. Biasing member 224d of release mechanism 220 functions to maintain or urge distal fingers 224c of arm portions 224b toward one another.

With continued reference to FIGS. 4-7, release mechanism 220 further includes a release button 228 operatively supported within housing 222 of release mechanism 220. Release button 228 includes a base portion 228a retained within housing 222 or release mechanism 220 and operatively engaged with, connected to or supported on both leg portions 224a of clasps 224. Release button 228 further includes a head portion 228b extending from housing 222 of release mechanism 220 and being configured and adapted to manipulation by a finger of a clinician.

In use, as will be described in greater detail below, when release button 228 is pressed (as indicated by arrow “A” of FIG. 5), release button 228 acts on leg portions 224a of clasps 224, moving the ends of leg portions 224a in a substantially distal direction and causing clasps 224 to rotate about pivot points 226 (as indicated by arrow “B” of FIG. 5) to move arm portions 224b and distal fingers 224c in a substantially outward direction (as indicated by arrow “C” of FIG. 5). Also, as clasps 224 are pivoted about pivot points 226, in the direction of arrow “B”, the free ends of biasing members 224d of clasps 224 are pressed against the surface of housing 222 of release mechanism 220 and are flexed or biased.

Release mechanism 220 is configured and adapted to enable the clinician to attach and remove blade assembly 250 to/from handle assembly 210 with a single hand. In particular, as will be discussed in detail below, the clinician may hold handle assembly 210 in a single hand, actuate release mechanism 220 with the same hand, and attach/detach bade assembly 250 to/from handle assembly 210 with the same hand. In this manner, contact of the clinicians other hand, with the blade assembly 250 or the like is eliminated, thereby reducing instances of contact or injury with the sharp of the blade assembly 250. In particular, the clinician may attach a new blade assembly to handle assembly using only a singe hand and may detach the blade assembly from the handle assembly using only a single hand.

As seen in FIGS. 4-7, blade assembly 250 includes an engagement structure or couple formation 256 formed in a surface of blade housing 252. Engagement structure 256 is configured and adapted to selectively engage with distal fingers 224c of each clasp 224 of release mechanism 220. Engagement structure 256 is configured and adapted such that a secure engagement between handle assembly 210 and blade assembly 250 is achieved when blade assembly 250 is coupled to handle assembly 210. Additionally, engagement structure 256 is configured and adapted such that upon actuation of the release button 228, blade assembly 250 is automatically separated from handle assembly 210.

With reference to FIGS. 5-7, a method of using surgical hair trimmer 200 with handle assembly 210 and blade assembly 250 is shown and described. As seen in FIGS. 5-7, blade assembly 250 is attached or connected to handle assembly 210, by approximating blade assembly 250 and handle assembly 210 until distal fingers 224c of clasps 224 snap-over and engage respective coupling formations 256 of blade assembly 250. In so doing, biasing members 224d of each clasp 224 is flexed or biased, as described above, and the forces on leg portions 224a of clasps 224 urge release button 228 to extend out of aperture 212d (see FIG. 4) of handle housing 212 and urge distal ends 224c of arm portions 224b toward one another.

Following use of surgical hair trimmer 200, blade assembly 250 is detached from handle assembly 210 and either discarded or sanitized for re-use. In order to detach blade assembly 250 from handle assembly 210, the clinician presses down on release button 228, as indicated by arrow “A” of FIG. 7, thereby pressing base portion 228a of release button 228 into and against leg portions 224a of clasps 224. As the ends of leg portions 224a of clasps 224 are urged in a downward direction, as indicated by arrow “A” of FIG. 7, clasps 224 are rotated about pivot points 226, as indicated by arrow “B” of FIG. 7. As clasps 224 are rotated about pivot points 226, distal fingers 224c of clasps 224 move outwardly, as indicated by arrow “C” of FIG. 7, to disengage from respective coupling formations 256 of blade assembly 250 and to further flex or bias biasing members 224d.

Once distal fingers 224c of clasps 224 are free from or fully disengaged from respective coupling formation 256 of blade assembly 250, blade assembly 250 is forced, pushed or jettisoned off of or detached from handle assembly 210 by the un-flexing or un-biasing force stored in biasing member 224d. When release button 228 is released, biasing members 224d will force or urge distal ends of fingers 224c toward one another.

It will be understood that various modifications may be made to the embodiments disclosed herein. Therefore, the above description should not be construed as limiting, but merely as exemplifications of preferred embodiments. Those skilled in the art will envision other modifications within the scope and spirit of the claims appended hereto.

What is claimed is:

1. A surgical hair trimmer, comprising:
a handle assembly including:
a handle housing configured and dimensioned to house a power supply and a drive motor, wherein the drive motor includes a drive shaft extending through a distal end of the handle housing; and
a release mechanism associated with the handle housing, the release mechanism including:
a pair of clasps each pivotally supported in a release housing at a respective pivot point, each clasp including a leg portion extending in a first direction from the pivot point and an arm portion extending in a second direction from the pivot point, the arm portion of each clasp defining a distal finger configured and adapted for engaging a blade assembly; and
a release button operatively associated with the leg portion of each clasp; and
a blade assembly selectively connectable to the handle assembly, the blade assembly including:
a blade housing configured and dimensioned to house a pair of trimmer blades; and
an engagement structure formed in blade housing for selectively engaging the distal finger of each arm portion of each clasp;
a biasing member operatively associated with each clasp for maintaining said arms in a first position relative to one another; and
wherein when the blade assembly is connected to the handle assembly the distal end of the arm of each clasp of the release mechanism engages with a corresponding engagement structure of the blade housing of the blade assembly, and wherein actuation of the release button of the release mechanism jettisons the blade assembly from the handle assembly.

2. The surgical hair trimmer according to claim 1, wherein the release button is provided on an upper surface of the handle housing.

3. The surgical hair trimmer according to claim 1, wherein the distal end of the arm of at least one clasp extends in an inward direction.

4. The surgical hair trimmer according to claim 1, further comprising at least one visual indicator supported on the handle housing.

5. The surgical hair trimmer according to claim 1, wherein a distal end of the handle housing includes a shroud extending therefrom.

6. The surgical hair trimmer according to claim 1, wherein the leg portion and the arm portion of each clasp are oriented at an angle with respect to one another.

7. The surgical hair trimmer according to claim 1, wherein the biasing member tends to maintain the distal end of each arm portion of each clasp relatively approximated toward one another.

8. The surgical hair trimmer according to claim 1, wherein the biasing member is operatively associated with at least one of the release mechanism and the blade assembly.

9. The surgical hair trimmer according to claim 8, wherein the biasing member includes at least one leaf spring extending from the blade housing and in operative contact with a respective leg portion of each clasp when the blade assembly is connected to the handle assembly.

10. The surgical hair trimmer according to claim 9, wherein the biasing member tends to maintain the release button in an extended condition when the blade assembly is connected to the handle assembly.

11. The surgical hair trimmer according to claim 8, wherein the biasing member includes at least one leaf spring extending from each clasp and in operative contact with the housing of the release mechanism.

12. The surgical hair trimmer according to claim 11, wherein the biasing member tends to maintain the release button in an extended condition when the blade assembly is connected to the handle assembly.

13. A surgical hair trimmer, comprising:
a handle assembly including a power source, a drive motor connected to the power source and having a drive shaft extending therefrom, and a release mechanism configured and adapted for single handed operation; and
a blade assembly including a pair of blades wherein at least one of the pair of blades is movable with respect to the other of the pair of blades, and engagement structure configured and adapted to selectively engage the release mechanism of the handle assembly,
wherein actuation of the release mechanism, when the blade assembly is connected to the handle assembly, jettisons the blade assembly from the handle assembly.

14. The surgical hair trimmer according to claim 13, wherein the release mechanism includes:
a pair of clasps each pivotally supported in a release housing at a respective pivot point, each clasp including a leg portion extending in a first direction from the pivot point and an arm portion extending in a second direction from the pivot point, the arm portion of each clasp defining a distal finger configured and adapted for engaging a blade assembly; and
a release button operatively associated with the leg portion of each clasp.

15. The surgical hair trimmer according to claim 14, wherein the blade assembly includes:
a blade housing configured and dimensioned to house a pair of trimmer blades; and
an engagement structure formed in blade housing for selectively engaging the distal finger of each arm portion of each clasp.

16. The surgical hair trimmer according to claim 15, further comprising a biasing member operatively associated with each clasp for maintaining said arms in a first position relative to one another;
wherein when the blade assembly is connected to the handle assembly the distal end of the arm of each clasp of the release mechanism engages with a corresponding engagement structure of the blade housing of the blade assembly, and wherein actuation of the release button of the release mechanism jettisons the blade assembly from the handle assembly.

17. The surgical hair trimmer according to claim 14, wherein the release button is provided on an upper surface of the handle housing.

18. The surgical hair trimmer according to claim 14, wherein the distal end of the arm of at least one clasp extends in an inward direction.

19. The surgical hair trimmer according to claim 13, further comprising at least one visual indicator supported on the handle housing.

20. The surgical hair trimmer according to claim 13, wherein a distal end of the handle assembly includes a shroud extending therefrom.

21. The surgical hair trimmer according to claim 14, wherein the leg portion and the arm portion of each clasp are oriented at an angle with respect to one another.

22. The surgical hair trimmer according to claim 16, wherein the biasing member tends to maintain the distal end of each arm portion of each clasp relatively approximated toward one another.

23. The surgical hair trimmer according to claim 16 wherein the biasing member is operatively associated with at least one of the release mechanism and the blade assembly.

24. The surgical hair trimmer according to claim 23, wherein the biasing member includes at least one leaf spring extending from the blade housing and in operative contact with a respective leg portion of each clasp when the blade assembly is connected to the handle assembly.

25. The surgical hair trimmer according to claim 24, wherein the biasing member tends to maintain the release button in an extended condition when the blade assembly is connected to the handle assembly.

26. The surgical hair trimmer according to claim 23, wherein the biasing member includes at least one leaf spring extending from each clasp and in operative contact with the housing of the release mechanism.

27. The surgical hair trimmer according to claim 26, wherein the biasing member tends to maintain the release button in an extended condition when the blade assembly is connected to the handle assembly.
